(19) United States
(12) Patent Application Publication
(10) Pub. No.: US 2014/0309807 A1
(43) Pub. Date: Oct. 16, 2014

(54) ESTIMATION OF RECOVERED ENERGY

(71) Applicant: RENAULT s.a.s., Boulogne-Billancourt (FR)

(72) Inventors: Hamid Azzi, Maurepas (FR); Aymeric Bruneau, Maisons-Laffitte (FR); Bruno Guilbert, Chaville (FR)

(73) Assignee: RENAULT s.a.s., Boulogne-Billancourt (FR)

(21) Appl. No.: 14/362,357

(22) PCT Filed: Dec. 3, 2012
(86) PCT No.: PCT/EP2012/074258

§ 371 Date: Jun. 24, 2014

(30) Foreign Application Priority Data
Dec. 5, 2011 (FR) 1161136

(51) Int. Cl. B60L 3/12

(52) U.S. Cl. CPC B60L 3/12
USPC 701/1

(57) ABSTRACT

A method of estimating energy recovered by a vehicle including a regenerative braking mechanism, with at least two energy recovery systems generating at least two respective setpoint values and configured for the regenerative braking mechanism, the method including receiving one of the setpoint values and calculating an energy value on the basis of the setpoint value received.

The invention relates to the estimation of energy recovered by a vehicle equipped with a regenerative braking means, for example an electric braking means.

The vehicle may be an electric vehicle or hybrid vehicle, for example.

In the case of a vehicle equipped with at least one electric traction or propulsion motor, it is possible, under certain conditions, to use the electric motor as a generator and to thus obtain an electric braking means. Such a use is advantageous because, since it is regenerative, it makes it possible to recover some of the energy in order to recharge the batteries.

When the driver presses on the brake pedal, an overall braking instruction output by this pedal can be converted at least in part into a regenerative braking instruction, for example into an electric braking instruction.

This energy recovery system can be supplemented by an auxiliary energy recovery system making it possible to recharge the battery on the basis of the signals output by the acceleration pedal.

In fact, electric braking can also be engaged when the driver lifts his foot from the acceleration pedal. In this last case, reference is made to braking-free deceleration.

In particular, document FR2945243 describes a method for generating such an artificial engine brake when the acceleration pedal is not engaged.

Attempts have been made to estimate the energy recovered by the battery by placing a current strength sensor at the input of the battery of the vehicle. This recovered energy value is an overall value and does not provide, per se, information concerning the performance of each of the recovery systems.

There is a need for an estimation of the performance or use of one or more of the energy recovery systems or each energy recovery system.

A method is proposed for estimating energy recovered by a vehicle equipped with a regenerative braking means and at least two energy recovery systems generating at least two respective setpoint values intended for the regenerative braking means, the method comprising a step of receiving one of said setpoint values and a step of calculating an energy value from this received setpoint value.

Thus, this energy value is calculated on the basis of a setpoint value belonging to an energy recovery system. This method thus makes it possible to estimate the energy recovered thanks to this system.

This estimation may make it possible to evaluate the contribution of this energy recovery system, both in the case of client usage and in the case of dedicated homologation cycles. Within the scope of client use, it is possible to obtain data concerning the performance and the added benefit of this energy recovery system, this data being suitable for averaging over a fleet of vehicles with decoupled pedal.

The at least two energy recovery systems may comprise, for example, a first system for recovering energy on the basis of signals output by the brake pedal and a second system for recovering energy on the basis of signals output by the acceleration pedal. This second energy recovery system may make it possible to simulate an engine brake when the driver lifts his foot from the acceleration pedal.

Since the vehicle is equipped with a number of energy recovery systems, a summer device may make it possible to add together the signals output by these respective systems. Advantageously, the received setpoint value may be the setpoint value also received at the input of the summer. The estimation of the energy associated with this recovery system is then conducted on the basis of the most sophisticated value specific to this system.

Advantageously and in a non-limiting manner, the method may comprise a step of receiving another value and a step of calculating an additional energy value on the basis of at least this other value.

Thus, the method may make it possible to evaluate the relative part of the energy recovery system for which a setpoint value has served as a basis for the energy calculation.

This other value may comprise, for example:
a measurement value obtained from a sensor, for example at the input of the battery—it is thus possible to estimate an overall recovered energy and a recovered energy associated with the energy recovery system, and/or
a setpoint value—a sensor can thus be spared.

This last setpoint value may comprise, for example:
a regenerative setpoint value obtained following a summation of the at least two setpoint values of the at least two energy recovery systems, and/or
the other of said setpoint values.

In the case of an estimation on the basis of a value representative of the overall recovered energy as the measurement value obtained by a sensor at the input of the battery or the regenerative setpoint value, it is possible to estimate an overall recovered energy value. If the vehicle is equipped with just two energy recovery systems, the recovered energy associated with the other energy recovery system can then be estimated by establishing a difference between the estimated value of overall recovered energy and the estimated value of energy associated with the energy recovery system.

When the other value on the basis of which an energy value is estimated is the other of the setpoint values, the energy estimations conducted then lead directly to energy values each associated with an energy recovery system.

The method described above may make it possible to distinguish the electrical energy data recovered when a foot is lifted from the accelerator pedal and during braking in the case of any client use, moreover for a large quantity of data averaged over a fleet of electric vehicles with decoupled pedal, an actual or virtual fleet of vehicles, belonging to the same entity, or a fleet of vehicles belonging to third parties, of which the management and servicing are undertaken by the same entity.

Advantageously and in a non-limiting manner, the method may comprise, for the received setpoint value and/or for the other value, a step of multiplication by a speed value of the vehicle so as to obtain a power value.

The different power values obtained can then be integrated temporally so as to obtain an energy value.

Advantageously and in a non-limiting manner, the estimated recovered energy value as well as a braked distance value associated with this estimated value, and/or a traveled distance value output from odometry data can be stored in a memory.

The braked distance value, for example in braked kilometers, may provide an indication of the efficacy of the energy recovery. The traveled distance value corresponding to these braked kilometers and/or to this energy value may provide an indication of the type of use of the vehicle having led to this energy recovery. For example, an energy recovered over 100 braked kilometers and 300 traveled kilometers may correspond to an urban use, whereas an energy recovered over 100 braked kilometers and 10 000 traveled kilometers may correspond to a use on a freeway.

Advantageously and in a non-limiting manner, the method may comprise a step of associating an energy value with a buffer memory. In fact, a number of buffer memories may be provided per vehicle so as to store more values.

Advantageously and in a non-limiting manner, the method may comprise a step of comparing the braked distance value associated with the energy value with a threshold. If the braked distance value exceeds this threshold, the integrator can be reset to zero, and the next energy value can be assigned to another buffer memory. Thus, the values read in the previous buffer memories correspond substantially to the same braked distance, for example 100 km.

A computer program comprising instructions for carrying out the steps of the method described above is also proposed.

A device is also proposed for estimating energy recovered by a vehicle equipped with a regenerative braking means and at east two energy recovery systems generating at least two respective setpoint values intended for the regenerative braking means, the device comprising means for receiving one of said setpoint values, for example an input port or a read bus, and means for calculating an energy value on the basis of this received setpoint value, for example a processor core.

This device, for example, may comprise or may be integrated in one or more processors, for example a microcontroller, a microprocessor, a DSP (digital signal processor), etc.

The energy estimation device may comprise resources for estimating the energy recovered on the basis of a command in which the foot is lifted from the acceleration pedal, resources for estimating the energy recovered on the basis of an electric braking command, and resources for saving recovered energy, comprising at least dynamic memories refreshed in accordance with a determined braked distance value.

The resources for estimating the energy recovered on the basis of a command in which the foot is lifted from the acceleration pedal may comprise:
divider means receiving a setpoint value of braking implemented by the lifting of a foot and a value of the radius of the wheels of the vehicle and providing a value of momentary force of braking by inertia;

multiplier means receiving the amplitude of the value of momentary force of braking by inertia and a value of the amplitude of the momentary speed of the vehicle and providing a value of momentary mechanical power recovered by inertia;
integrator means receiving the value of momentary mechanical power recovered by inertia and initialization values and providing over the braking duration/distance a value of mechanical energy recovered by inertia.

The resources for estimating the energy recovered on the basis of an electric braking command may comprise:
divider means receiving a setpoint value of electric braking and the value of the radius of the wheels of the vehicle, these divider means providing a value of momentary electric braking force;
multiplier means receiving the amplitude value of momentary electric braking force and the value of the amplitude of the momentary speed of the vehicle and providing a value of momentary recovered electric power;
integrator means receiving the value of momentary recovered electric power and initialization values and providing over the braking duration/distance a value of recovered electrical energy.

The memory resources may comprise:
a first current buffer memory for storing the mechanical energy and electrical energy values recovered during a current movement of the vehicle;
a plurality of specific buffer memories each intended to store the mechanical energy and electrical energy values recovered on the basis of determined braked distance ranges.

A vehicle, for example a motor vehicle, comprising the device described above, and also the recovery systems and a regenerative braking means is also proposed.

In the present application, the notion of a vehicle with electric drive includes that of complete electric drive and/or hybrid drive.

The device according to the invention will be better understood upon reading the description and inspecting the drawings hereinafter, in which:

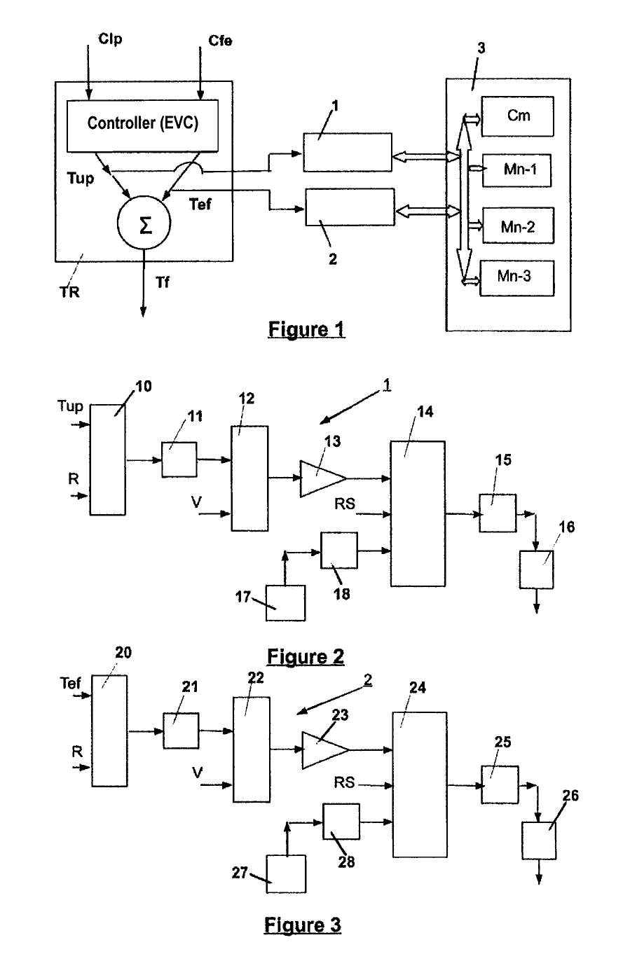

FIG. 1 shows a functional diagram of an example of a device for controlling the recovery of braking energy of a vehicle with electric drive in accordance with an embodiment of the present invention;

FIG. 2 shows an implementation detail of an estimation of the energy recovered on the basis of a command in which the foot is lifted from the acceleration pedal in accordance with an embodiment of the present invention;

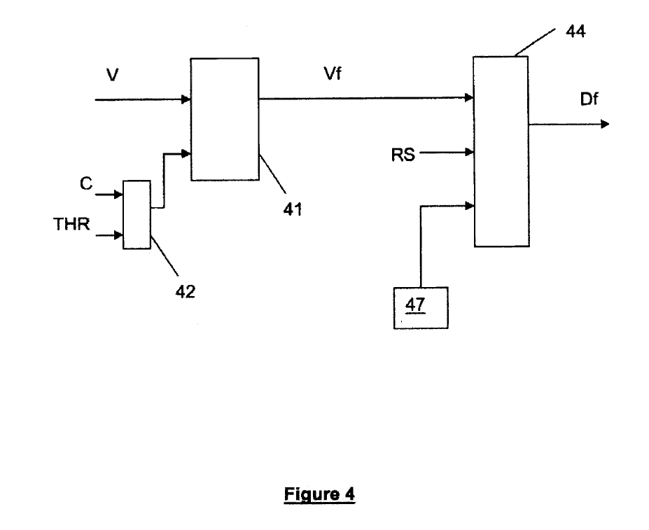

FIG. 3 shows an implementation detail of an estimation of the energy recovered on the basis of an electric braking command in accordance with an embodiment of the present invention;

FIG. 4 shows a functional diagram of an example of a braked distance estimator for the purpose of storage in memory resources in accordance with an implementation of the invention.

With reference to FIG. 1, a device for controlling the braking energy recovery of a vehicle with electric drive comprises a torque vectoring system TR. This torque vectoring system TR comprises a computing module or controller (EVC), receiving a command signal Clp output by an acceleration pedal, and an electric braking command signal Cfe, output by a distribution device (not shown).

This distribution device (torque blending system) receives, at its input, an overall braking command signal, output by a brake pedal, and also other signals, for example a vehicle speed signal. The distribution device is set up so as to determine, on the basis of the overall braking command signal, an electric braking command signal Cfe intended for the electric braking means, and a complementary braking command signal intended for the complementary braking means, for example a hydraulic braking means. For example, the distribution device comprises a saturator for saturating the overall command signal by a maximum value of braking achievable by the electric braking means. The electric braking command signal Cfe may be selected so as to be equal to this saturated value. Then, the saturated value is subtracted from the overall command value received at the input, and the complementary braking command signal is selected so as to be equal to this difference. The distribution device may thus comprise a saturator and a subtractor. In addition, the distribution device may be set up so as to prevent electric braking when the speed of the vehicle is below a threshold, for example 7 km/h. In other words, for low speeds, the complementary braking command signal is selected so as to be equal to the overall command signal output directly by the brake pedal.

The controller EVC thus receives the electric braking command signal Cfe determined by the distribution device in accordance with the effective contact force on the brake pedal, and also the command signal Clp output by the acceleration pedal. This signal Clp indicates the state of the acceleration pedal.

The controller EVC is set up to develop an applied setpoint value of torque produced by the lifting of a foot, said value being referred to as Tup, on the basis of the acceleration pedal state signal Clp, when a foot on this pedal is lifted. The controller can develop this signal Tup by implementing, for example, the method described in document FR2945243. The signal Tup makes it possible to simulate the engine braking in the case that the driver lifts his foot from the acceleration pedal so that the driver retains the feeling of braking when his foot is lifted, even if this braking is electric.

The controller EVC is set up so as to also calculate an applied electric braking torque setpoint, referred to as Tef, on the basis of the electric braking command signal Cfe. The controller in particular can apply a reducer ratio so as to convert the value of the wheel torque signal Cfe into an engine torque value. In addition, some saturations may be produced.

The values of these applied torque commands Tup, Tef are summed, and the sum Tf thus obtained makes it possible to control the engine braking as a result.

Thus, a first recovery system makes it possible to implement electric braking on the basis of the signals output by the brake pedal, and a second recovery system makes it possible to implement electric braking on the basis of the signals output by the acceleration pedal.

The first recovery system in particular comprises the distribution device, means for receiving the signal Cfe, for example an input port, and means for calculating the signal Tef, for example a processor core.

The second distribution system in particular comprises means for receiving the signal Clp, for example an input port, and means for calculating the signal Tup, for example a processor core.

The device also comprises means for estimating the energy recovered during braking by each recovery system on the basis of the applied braking torque command values. The energy recovered during braking is estimated on the basis of the aforementioned command values, that is to say the setpoint values of applied braking torque produced by the lifting of a foot, Tup, and of applied electric braking torque, Tef.

A module 1 makes it possible to estimate the energy recovered following a command in which the foot is lifted from the acceleration pedal, and a module 2 makes it possible to estimate the energy recovered following a braking command.

Each module 1, 2 comprises means for receiving the values of the respective signals Tup, Tef, for example read buses, one or more input pins, one or more conductor wires connected to one or more input pins, and/or input ports. These modules 1, 2 are also set up to receive a signal representative of the speed of the vehicle, and a memory able to store a wheel radius value. Each module 1, 2 also comprises processing means for calculating, respectively, two energy values on the basis of these received values, the speed of the vehicle and the wheel radius value. These processing means, which may be integrated in the same processor or in separate processors, will be described further with reference to FIGS. 2 and 3.

In addition, memory resources for storing recovered mechanical and electrical energies bearing the reference 3 are provided. The aforementioned memory resources advantageously comprise dynamic memories refreshed in accordance with a determined braked distance value. It is understood in particular that the set-up of the aforementioned memory resources makes it possible to disregard any specific path of the vehicle, only the braked distance being taken into account for the refresh of the aforementioned memories, as will be described further below in the description.

The means for estimating the energy recovered on the basis of a command in which the foot is lifted from the acceleration pedal will now be described in conjunction with FIG. 2.

With reference to the aforementioned figure, the means 1, in a preferred, non-limiting embodiment, comprise a divider 10 receiving the applied value of braking torque produced by the lifting of a foot Tup and the value R of the wheel radius of the vehicle in question. The divider 10 delivers a momentary value of the force of braking by engine inertia to a module 11 for calculating the absolute value of the aforementioned force.

The absolute value of this force is itself delivered to a multiplier 12 also receiving the value of the amplitude of the momentary speed V of the vehicle. The multiplier 12 delivers a value of momentary mechanical power recovered by inertia to an integrator module 14.

The momentary mechanical power value delivered to the integrator module 14 is preferably standardized by a divider circuit 13, making it possible for example to express directly the aforementioned momentary power in kW, for example.

The integrator module 14 also receives a zero reset signal, RS, or “reset”, as well as initialization values, such as an initial value, which is stored in the memory 17, and a unit conversion value 18, such that the integrator module 14 delivers the momentary power value integrated directly in energy units, such as kilojoules (kJ), for example. In this hypothesis, the unit conversion value 18 is the value 3600.

In addition, the aforementioned energy value corresponding to the braking energy recovered by inertia delivered by the integrator module 14 can then preferably be subjected to a conversion into kilowatt hours by a module 15, this module being a divider by the value 3600, and also subjected to a correction 16 by a yield factor referred to as K, corresponding to the conversion losses introduced between the wheels and the battery, by the energy recovery system.

The value of the aforementioned yield factor can be established experimentally for each type of vehicle and each energy recovery system.

The means for estimating the energy recovered on an electric braking command will now be described in conjunction with FIG. 3.

It can be seen in FIG. 3 that the references of the elements 20 to 28 particularly advantageously denote the same elements as the elements 10 to 18 respectively in FIG. 2. However, the input value of the divider 20 naturally corresponds to the value of applied electric braking torque Tef, substituted for the value of applied braking torque produced by the lifting of a foot Tup of FIG. 2.

Thus, it is understood that the divider 20 delivers a value of electric braking force, that the multiplier 22 delivers the momentary recovered electric braking power, and that the integrator module 24 delivers the value of momentary recovered electric power. The parameters of speed V and of radius R of the wheels of the vehicle are identical to those in FIG. 2, and the operating mode of the intermediate modules 21, 23, 25 and 26, 27, 28 is similar to that of the modules 11, 13, 15 and 16, 17, 18 respectively of FIG. 2.

A more detailed description of the set-up of the memory resources 3 will now be given in conjunction with FIG. 1.

As shown in the aforementioned figure, the memory resources 3 comprise at least one current first buffer memory or buffer (memory block), referred to as Cₘ. This buffer memory Cₘ is intended to store the values of energy recovered during a current movement of the vehicle, these values being received by the modules 1, 2.

A plurality of specific buffer memories, referred to as Mₙ₋₁, Mₙ₋₂, Mₙ₋₃, is also provided. Each buffer memory is intended to store the values of recovered mechanical energy and electrical energy on the basis of determined braked distance ranges.

The operating mode of the memory resources is as follows: the current memory Cₘ is refreshed upon termination of the controller EVC, and the estimation resources 1 and 2 and the specific memories Mₙ₋ᵢ to Mₙ₋₃ are refreshed when the braked kilometers are reached.

In a preferred non-limiting embodiment, the aforementioned specific memories may advantageously be dedicated each to specific braked distance ranges, corresponding to the duration of the service life of the vehicle. Such a set-up makes it possible not only to differentiate between each journey of the vehicle, but also to organize the control of the energy recovery of the vehicle, taking into account the service life and servicing steps of the vehicle.

In particular, the aforementioned memories can be formed by programmable memories receiving the indicators specific to the life and use of the vehicle, such as the odometry of the vehicle. Lastly, the dynamic parameters of the vehicle are specified during use of the vehicle, that is to say parameters such as momentary speed, distance traveled and of course distance braked can be delivered by the ESC controller for example or can be deduced from an information item delivered by a GPS system fitted in the vehicle.

The braked distance is calculated on the basis of the momentary speed and by the braking torque.

FIG. 4 illustrates an example for estimating braked distance.

With reference to this figure, a module 42 receives:
an overall braking torque value C output by a module (not shown), making it possible to interpret the signals of sensors sensing the position of the brake pedal and to recalculate a braking torque for the vehicle, and
a threshold value THR.

When the braking torque value is less in terms of absolute value than the threshold value THR, the output of the module 42 is a signal of value equal to zero. In the opposite case, this output signal has a value equal to 1.

This threshold THR can be selected so as to be relatively low, for example equal to zero.

A multiplier module 41 receives, at the input, values of momentary speed V of the vehicle as well as the values of the output signal of the module 42 corresponding to the same time samples. The speed signal during braking Vf thus has a value equal to the value of the speed signal V only when the value of the torque signal C is greater than the threshold value THR.

This signal Vf is then integrated as a function of time, thanks to an integrator module 44 also receiving a zero reset signal, RS, or “reset” as well as initialization values, such as an initial value stored in the memory 47.

The integrator module thus makes it possible, by temporal integration of speed values, to obtain an estimation of the braked distance Df.

Variant

In an alternative embodiment, the processing means denoted by 2 receive, at the input, the signal Tf rather than the signal Tef. The energy estimated by these processing means then corresponds to an overall recovered energy. The other of the processing means 1 makes it possible to estimate the energy associated with the energy recovery system corresponding to the acceleration pedal.

This variant can be advantageous in the sense that the estimation is performed on the basis of an effectively applied value, having possibly undergone processing after the summer. In addition, this variant may make it possible to avoid certain conversions.

The estimation device can be housed in the distribution device, in one of the energy recovery systems, in the controller EVC, or otherwise.

1-11. (canceled)

12. A method for estimating energy recovered by a vehicle including a regenerative braking means and at least two energy recovery systems generating at least two respective setpoint values configured for the regenerative braking means, the method comprising:
receiving one of the setpoint values; and
calculating an energy value from the received setpoint value.

13. The method as claimed in claim 11, further comprising:
receiving another value; and
calculating an additional energy value on the basis of at least the another value.

14. The method as claimed in claim 13, wherein the another value comprises another of the setpoint values.

15. The method as claimed in claim 13, wherein the another value comprises a value obtained by summing the setpoint values.

16. The method as claimed in claim 12, further comprising, for the received setpoint value:
multiplication by a speed value of the vehicle to obtain a power value;
temporal integration of the obtained power value to obtain an energy value.

17. The method as claimed in claim 11, further comprising:
storing in a memory the estimated recovered energy value and a braked distance value associated with the estimated value.

18. The method as claimed in claim 17, wherein the braked distance value is calculated on the basis of a vehicle speed signal and on the basis of a braking torque signal.

19. The method as claimed in claim 11, wherein the at least two energy recovery systems comprise a first system for recovering energy on the basis of signals output by a brake pedal and a second system for recovering energy on the basis of signals output by an acceleration pedal.

20. A device for estimating energy recovered by a vehicle including a regenerative braking means and at least two energy recovery systems generating at least two respective setpoint values configured for the regenerative braking means, the device comprising:
means for receiving one of the setpoint values;
means for calculating an energy value on the basis of the received setpoint value.

21. The device as claimed in claim 20, further comprising at least one buffer memory configured to store the energy value received from the calculation means and a braked distance value associated with the energy value.

22. A vehicle comprising the regenerative braking means, the at least two energy recovery systems, and the energy estimation device as claimed in claim 20.
